(19) United States
(12) Patent Application Publication
(10) Pub. No.: US 2023/0222355 A1
(43) Pub. Date: Jul. 13, 2023

(54) DISTRIBUTED NEURAL NETWORK COMMUNICATION SYSTEM

(71) Applicant: INQ. HOLDING LIMITED, Ebene (MU)

(72) Inventors: Pramod VENKATESH, Bangalore (IN); Andile NGCABA, Johannesburg (ZA)

(21) Appl. No.: 18/094,701

(22) Filed: Jan. 9, 2023

Related U.S. Application Data
(60) Provisional application No. 63/298,313, filed on Jan. 11, 2022.

(51) Int. Cl. G06N 3/098; G06N 5/04

(52) U.S. Cl. CPC G06N 3/098; G06N 5/04

(57) ABSTRACT

The invention provides a distributed neural network communication system for optimizing video analytics inference on an edge computing device. The system includes an edge system and a cloud system communicatively coupled to each other, the edge system being configured to receive an input data stream from an input device and to conduct partial or preliminary feature extraction at the edge system, and the cloud system being configured to communicate with the edge system to receive an extracted feature vector from the edge system and to conduct further feature extraction at the cloud system to yield a final feature vector, thereby enhancing accuracy of a neural network of the distributed neural network communication system. A distributed neural network communication method and a computer program product for distributed neural network communication are also provided.

### CROSS-REFERENCE TO RELATED APPLICATIONS

This application claims the benefit of U.S. Provisional Application No. 63/298,313 filed Jan. 11, 2022, and entitled “DISTRIBUTED NEURAL NETWORK COMMUNICATION SYSTEM”, the content of which is incorporated herein by reference in its entirety.

### FIELD OF THE INVENTION

The invention relates to a distributed neural network communication system. The invention also relates to a method of using such a system to optimize neural network analytics. Embodiments of the invention provide a distributed, secure neural network communication system for optimizing a video analytics inference process on an edge computing device.

### BACKGROUND

Edge computing is a distributed information technology paradigm and architecture in which computation and data storage are brought closer to the sources of data. The advent of edge computing has been beneficial for artificial intelligence (AI) applications. In particular, as “the edge” becomes more powerful and cost-effective to utilize, it allows AI models to be run on edge computing systems (as opposed to the traditional cloud-based architecture in which these models are run on remote servers or data centers).

Currently, many edge systems offer sufficient processing power to run AI models for a multitude of video, audio and data applications. However, the reality is that (at least for the foreseeable future) irrespective of how powerful edge systems become, they struggle to compete with powerful remote servers, e.g., a powerful server or cluster of servers with high memory graphics processing units (GPUs) which can run faster and provide greater accuracy than an edge system. This is, among other things, due to the limitations on power and computational ability of edge systems and the relative cost of these systems.

One of the key elements typically required of an AI model is “inference” ability. This term refers to the ability to take in data and assess the information based on training which was performed through prior data sets. It is the ability to generate conclusions, or deduce new information, based on the application of logical rules.

The inference accuracy of a deep learning neural network is usually dependent on (1) the required parallel floating-point operations per second (FLOPS) to run the deep learning neural network and (2) the memory required to hold the model. Typically, since edge devices are not as powerful as the cloud, edge models are smaller in footprint compared to larger models run on the cloud which require greater processing ability.

The use of these smaller edge models usually comes at a cost, as less memory and a lower number of FLOPS typically also means less accuracy (e.g., mean average precision in the context of detection accuracy) when compared to larger models run in the cloud.

This issue may become even more prominent in the field of video analytics, where visual data inference is required, e.g., in connection with object detection, segmentation and classification. The Applicant has found that a typical edge model may be up to 50% or 60% less accurate than a cloud-based model when it comes to video analytics.

Naturally, the abovementioned limitations and drawbacks are undesirable. In particular, because edge models are usually less accurate than cloud-based models, they perform worse than cloud-based models in real-world environments, with users for instance missing out on important detections. This may reduce the appeal of edge systems and even AI generally.

In light of the above, a need has been identified for an enhanced system and method that can introduce higher accuracy without significantly increasing computing requirements, particularly when dealing with video analytics. Embodiments of the present invention aim to address this need, at least to some extent.

### BRIEF SUMMARY

In accordance with one or more aspects of the invention, broadly, there is provided a distributed neural network communication system which includes an edge system and a cloud system communicatively coupled to each other, the edge system being configured to receive an input data stream from an input device and to conduct partial or preliminary feature extraction at the edge system, and the cloud system being configured to communicate with the edge system to receive an extracted feature vector from the edge system and to conduct further feature extraction at the cloud system to yield a final feature vector, thereby to enhance the accuracy of the neural network.

More specifically, in accordance with a first aspect of the invention, there is provided a distributed neural network communication system, the communication system including an edge system and a cloud system communicatively coupled to each other. The edge system is configured to: receive an input data stream from an input device; extract a preliminary feature vector from the input data stream through a preliminary feature analysis process; compress and/or encrypt the preliminary feature vector; and transmit the compressed and/or encrypted preliminary feature vector to the cloud system. The cloud system is configured to: receive the compressed and/or encrypted preliminary feature vector from the edge system; decrypt and/or decompress the preliminary feature vector; and analyze the decrypted and/or decompressed preliminary feature vector through an inference engine which implements a model associated with an artificial neural network, thereby yielding a final feature vector.

The edge system may be an edge computer directly connected to the input device and connected to the cloud system via the Internet. The model run by the cloud system may be a full AI model designed to detect objects/events and/or draw inferences from the input data stream.

The input device may be a video camera; and the input data stream may be in the form of video data.

The preliminary feature analysis process may include motion detection or object detection, involving dividing frames of the input data stream (video data) into frame blocks and analyzing each frame block to check its structural similarity to previous frames or frame blocks. Subsequently, as part of the preliminary feature analysis process, feature extraction may be carried out based only on the frame blocks in respect of which significant changes were detected.

The preliminary feature vector and/or final feature vector may be associated with a detected object or a detected event.

The cloud system may be coupled to a plurality of edge systems, each edge system transmitting compressed and/or encrypted preliminary feature vectors to the cloud system. The cloud system may include a message broker which is configured to handle streams of incoming messages from edge systems, each message including a compressed and encrypted preliminary feature vector along with metadata associated with the preliminary feature vector.

The cloud system may be configured such that analysis is conducted by separate worker nodes or worker modules substantially in parallel, each worker node/module implementing the inference engine in respect of a different feature vector or feature vector stream, thereby distributing AI tasks across difference devices, instances or processors.

The communication system may further be configured to implement a feedback mechanism. The cloud system may be configured to determine whether a collection rate or sampling rate should be increased or decreased and to communicate this to the edge system, via the feedback mechanism, as an input instruction.

In accordance with a second aspect of the invention, there is provided a distributed neural network communication method that includes: receiving, at an edge system which is communicatively coupled to a cloud system, an input data stream from an input device; extracting, by the edge system, a preliminary feature vector from the input data stream through a preliminary feature analysis process; compressing and/or encrypting, by the edge system, the preliminary feature vector; transmitting the compressed and/or encrypted preliminary feature vector to the cloud system; decrypting and/or decompressing the preliminary feature vector at the cloud system; and analyzing, by the cloud system, the decrypted and/or decompressed preliminary feature vector through an inference engine which implements a model associated with a neural network, thereby yielding a final feature vector.

In accordance with a third aspect of the invention, there is provided a computer program product for distributed neural network communication, the computer program product including at least one computer-readable storage medium having program instructions embodied therewith, the program instructions being executable by at least one computer to cause the at least one computer to carry out the method substantially as described above. The computer-readable storage medium may be a non-transitory storage medium.

The further features summarized with reference to the first aspect (system) of the invention above may apply mutatis mutandis to the second aspect (method) and/or third aspect (computer program product) of the invention.

### BRIEF DESCRIPTION OF THE DRAWINGS

The invention will now be further described, by way of example, with reference to the accompanying drawings. In the drawings:

FIG. 1 is a schematic illustration providing an overview of an embodiment of a system according to aspects of the invention;

FIG. 2 is a schematic diagram illustrating further detail of the system of FIG. 1, as well as certain steps and processes in an exemplary method according to aspects of the invention; and

FIG. 3 is a block diagram of an exemplary computer system capable of executing a computer program product to provide functions and/or actions according to at least some aspects of the invention.

### DETAILED DESCRIPTION

The following description is provided as an enabling teaching of aspects of the invention, is illustrative of principles associated with the invention, and is not intended to limit the scope of the invention. Changes may be made to the embodiments depicted and described herein, while still attaining results of the present invention and/or without departing from the scope of the invention. Furthermore, it will be understood that some results or advantages of the present invention may be attained by selecting some of the features of the present invention without utilizing other features. Accordingly, those skilled in the art will recognize that modifications and adaptations to the present invention may be possible, and may even be desirable in certain circumstances, and may form part of the present invention.

Embodiments of the invention provide a distributed, secure neural network communication system for optimizing video analytics inference on an edge computing device.

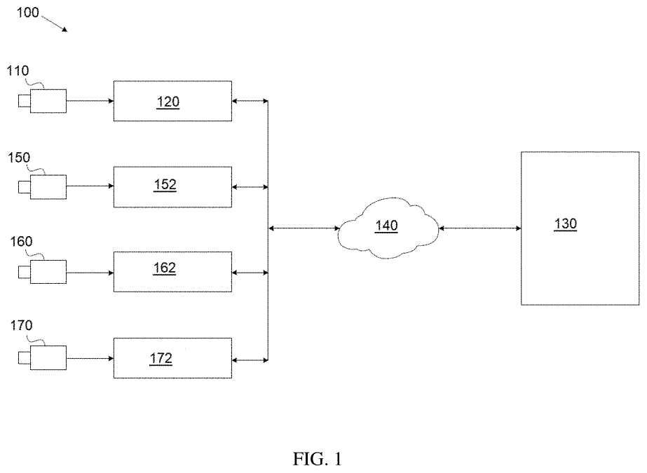

Referring to FIG. 1, such a system 100 may include multiple edge systems 120, 152, 162, 172 connected via the Internet 140 to a cloud system 130. The edge systems 120, 152, 162, 172 are each connected to an input device, in this case a video camera 110, 150, 160, 170, for purposes of processing video streams from the video cameras 110, 150, 160, 170.

It will be appreciated that there may typically be a many-to-one relationship between the edge systems and the centralized cloud system, i.e. the cloud system may service a large number of edge systems to optimize analytics for devices associated with those edge systems. However, for ease of reference and to facilitate understanding of certain aspects of the invention, only one edge system, being the edge system 120, will be referred to in the description below.

Furthermore, it will be appreciated that while the input device is a video camera 110 in this example of the invention, techniques described herein may be applied to other input data and embodiments of the invention are not limited to video analytics.

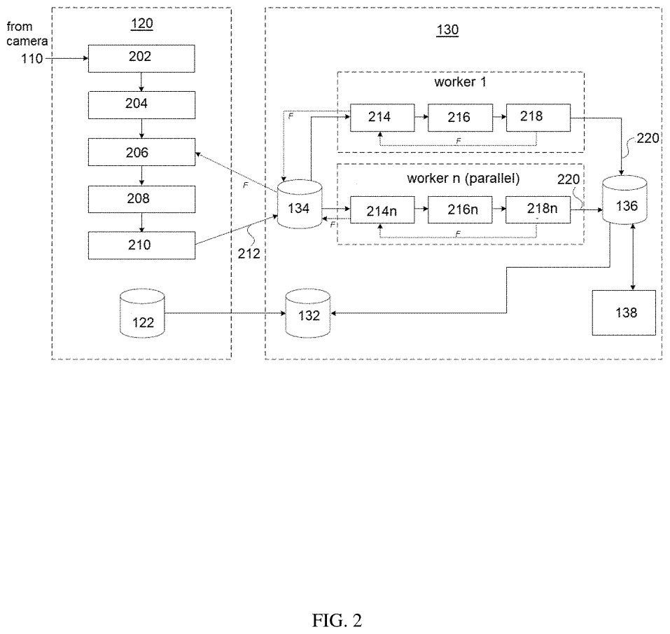

The system 100 is designed to provide higher AI model accuracy without increasing computing power requirements. Broadly speaking, this is achieved by utilizing a distributed communication protocol which is described in detail below with reference to FIG. 2. In this example embodiment, the protocol is designed specifically for neural network vectors. Data stream processing is divided into multiple stages and distributed across “the edge” and “the cloud”. A unique feature extraction technique is used so as to be able to run partial AI feature extraction on the edge system 120 and, using the communication protocol which can exchange the output of the feature extraction, further extraction may then be run on the centralized cloud system 130 to provide enhanced accuracy.

As will become more readily apparent from the description below, the system 100 and the associated process are advantageous in that they obviate the need to send, for instance, full video streams to the cloud system 130 which would necessitate higher bandwidth. Instead, only feature vectors which will be used for further analysis are transmitted from the edge system 120 to the cloud system 130, making it much more efficient while enhancing accuracy. A feature vector compression algorithm may be used to further reduce the necessary bandwidth and feature vectors may be stored in a vector database for further analysis/future use.

Referring now to FIG. 2 which provides more detail and illustrates a specific exemplary embodiment, the edge system 120 is coupled directly to the camera 110 and receives a video stream from the camera 110 (stage 202 in FIG. 2). The camera 110 may, for instance, be a surveillance camera or a camera installed to monitor a public road or other area for crime prevention/reduction. The edge system 120 may, for instance, be a suitable computer which is locally connected to the camera 110, i.e., not a cloud-based computing device. The neural network implemented by the systems 120, 130 may for instance be designed to detect specific objects, e.g., license plates through license plate recognition or humans through facial recognition, or specific events, e.g., unauthorized access to a premises or loitering. The AI model in question may thus provide “AI vision as a service”.

In this example, the edge system 120 carries out motion detection on the video stream from the camera 110 at stage 204. The system 120 is accordingly configured to check for object motion. In this exemplary embodiment, instead of using the full frame from the video stream for motion detection (which cannot pinpoint where the motion is actually occurring), the system 120 divides the incoming video into smaller pieces, or “blocks”, i.e., adaptable frame blocks. Each frame block is analyzed separately and compared with previous frames to check their structural similarity index. Motion detection is thus carried out based on change in structural similarity between frame blocks from different frames.

Only the frame blocks in respect of which a significant change has been detected are selected by the system 120. In other words, only the relevant frame blocks, from a motion detection perspective, are taken and pieced together, with the remainder of the blocks being discarded by the system 120. The frame blocks that are retained by the system 120 for further analysis may be referred to as the “resultant blocks”. A significant change can be identified based on one or more thresholds or predetermined conditions.

At stage 206 the edge system 102 carries out feature extraction in respect of the resultant blocks. In other words, the (larger) set of input data associated with the raw resultant blocks is transformed into a reduced set of predefined features known as a feature vector. The resultant blocks may be passed to a feature extraction library to extract the feature vector (or multiple feature vectors). The feature vector can be extracted at any of the stages 206, 208 or 210 depending on the edge system's performance.

In this example, at stage 208 the extracted feature vector is run through a compression algorithm to reduce the overall size of the vector. After compression, additional metadata is added which may provide, for instance, a frame number or other identifier, extracted segments and blocks, and compression parameters.

The compressed data, which includes the feature vector, together with the additional metadata, may then be encrypted at stage 210 and transmitted to the central cloud system 130. The data may be transmitted as an encrypted message in any suitable format. Transmission control protocol (TCP) may for example be used to transmit streams of encrypted messages to the cloud system 130 via the Internet 140.

Each edge system would thus typically send streams of extracted, compressed and encrypted feature vectors to the cloud system 130 for further processing.

At the cloud system 130, messages are received by a centralized message broker 134, or message queue, at stage 212. As mentioned above, while this example only refers to the edge system 120, in use the cloud system 130 may receive (at the broker 134) feature vector streams from multiple edge systems (the system 130 may be linked to hundreds or thousands of edge devices). The broker 134 may be configured to hold messages temporarily before they are picked and processed.

The cloud system 130 is configured to implement multiple worker nodes, e.g., multiple instances with high powered GPUs which de-queue compressed feature vectors from the edge system 120 and send them to further stages for extraction and analysis. FIG. 2 shows a first worker node, labelled “Worker 1”, and an “n-th” worker node, labelled “Worker n”, the latter being shown to illustrate that multiple worker nodes typically operate in parallel.

Using Worker 1 as an example, the worker node decrypts and extracts the feature vector it has received using the appropriate decryption technique and a predefined decompression algorithm (stage 214). Worker 1 makes use of the metadata of the relevant feature vector to obtain the required information for decryption, decompression and/or extraction. Then, at stage 216, an inference engine which runs on an appropriate GPU with the full AI model loaded in memory carries out the necessary analysis and inference as required by the application. For instance, the feature vector may be passed on to an inference pipeline to be run in order to extract the required inferred data and bounding box (e.g., a rectangle that surrounds an object, specifying its position, class (e.g., car or person) and confidence (how likely it is to be at that location)). This may consist of the higher order inference parameters required for convolutional networks. The model may for instance run fully connected “layer” and “Softmax” operations (e.g., a Softmax layer implemented through a neural network layer just before the output layer). The inference engine then outputs a final feature vector (or multiple final feature vectors).

Accordingly, partial AI feature extraction is carried out at the edge system 120 and the feature vector generated at the edge system 120 may be referred to as a “preliminary feature vector”, while further processing and inference is carried out at the more powerful central system 130 which then yields a “final feature vector”.

The systems 120, 130 according to this embodiment of the invention incorporate a feedback mechanism. The feedback mechanism is based on the final feature vector, e.g., the final object detected by the AI model, to either increase the sampling rate or decrease the sampling rate. The arrows shown in broken lines in FIG. 2 illustrate feedback steps and are marked “F”. Referring to stage 218 specifically, the results from the inference engine at stage 216 are run through a feedback engage and the feedback is communicated to the edge system 120 to, for instance, enhance the collection rate or drop the collection rate.

The feedback engine may also allow for the system to reduce the rate of collection, e.g., it may instruct the system to increase or reduce the frames per second (FPS), bitrate quality, or the like, based on the detections performed.

In use, final feature vectors resulting from the stages described above may then be stored in a suitable data storage system 136, e.g., a vector database, for future use and/or further processing (see stage 220 in FIG. 2).

The cloud system 130 is further configured to carry out central “orchestration”/management. Referring to block 138 in FIG. 2, this component allows for user input to be stored, e.g., in the storage 136 or in a configuration engine 132 of the cloud system 130. The edge system 120 in turn has a corresponding configuration engine 122. The required configuration, as for instance input by a user, may then be pulled from each processor in order to distribute AI tasks across different devices/instances in the most appropriate manner

The data in the storage system 136 may be analyzed further, e.g., using a rules engine or through predictive analytics, and the system 130 may further be configured to “act” on detections, e.g., to transmit alerts to client devices. Alerts may, for instance, be accompanied by a “snapshot” of what has been detected by the system. Clients may be provided with customized analytics.

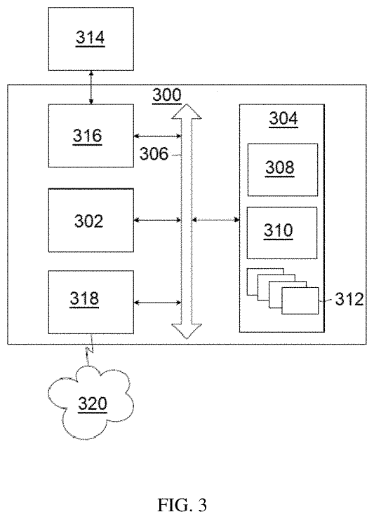

The techniques described above may be implemented in or using one or more computer systems, such as the computer system 300 shown in FIG. 3. The computer system 300 may be or include any suitable computer or server. The system 120, the system 130 and/or other parts of the communication system described herein may include such a computer system 300. The computer system 300 may be implemented in distributed cloud computing environments where tasks are performed by remote processing devices that are linked through a communications network. In a distributed cloud computing environment, program modules executed by the computer system 300 may be located both locally and remotely.

In the example shown in FIG. 3, the computer system 300 has features of a general-purpose computer. These components may include, but are not limited to, at least one processor 302, a memory 304 and a bus 306 that couples various components of the system 300 including the memory 304 to the processor 302. The bus 306 may have any suitable type of bus structure. The computer system 300 may include one or more different types of readable media, such as removable and non-removable media and volatile and non-volatile media.

The memory 304 may thus include volatile memory 308 (e.g., random access memory (RAM) and/or cache memory) and may further include other storage media such as a storage system 310 configured for reading from and writing to a non-removable, non-volatile media such as a hard drive. It will be understood that the computer system 300 may also include or be coupled to a magnetic disk drive and/or an optical disk drive (not shown) for reading from or writing to suitable non-volatile media. These may be connected to the bus 306 by one or more data media interfaces.

The memory 304 may be configured to store program modules 312. The modules 312 may include, for instance, an operating system, one or more application programs, other program modules, and program data, each of which may include an implementation of a networking environment. The components of the computer system 300 may be implemented as modules 312 which generally carry out functions and/or methodologies of embodiments of the invention as described herein. It will be appreciated that embodiments of the invention may include or be implemented by a plurality of the computer systems 300, which may be communicatively coupled to each other.

The computer system 300 may operatively be communicatively coupled to at least one external device 314. For instance, the computer system 300 may communicate with external devices 314 in the form of a modem, keyboard and display. These communications may be effected via suitable Input/Output (I/O) interfaces 316.

The computer system 300 may also be configured to communicate with at least one network 320 (e.g., the Internet or a local area network) via a network interface device 318/network adapter. The network interface device 318 may communicate with the other elements of the computer system 300, as described above, via the bus 306.

The components shown in and described with reference to FIG. 3 are examples only and it will be understood that other components may be used as alternatives to or in conjunction with those shown.

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions, which may be on-site, cloud-based, distributed, blockchain or ledger-based, or the like.

Instructions may be provided to a processor of any suitable computer or other apparatus such that the instructions, which may execute via the processor of the computer or other apparatus, establish or generate means for implementing the functions or actions identified in the figures.

What is claimed:

1. A distributed neural network communication system comprising an edge system and a cloud system communicatively coupled to each other, wherein the edge system is configured to receive an input data stream from an input device and to conduct partial or preliminary feature extraction at the edge system, and the cloud system is configured to communicate with the edge system to receive an extracted feature vector from the edge system and to conduct further feature extraction at the cloud system to yield a final feature vector, thereby to enhance accuracy of a neural network of the distributed neural network communication system.

2. The distributed neural network communication system as claimed in claim 1,
wherein the edge system is configured to:
receive the input data stream from the input device;
extract a preliminary feature vector from the input data stream through a preliminary feature analysis process;
compress and/or encrypt the preliminary feature vector; and
transmit the compressed and/or encrypted preliminary feature vector to the cloud system;
wherein the cloud system is configured to:
receive the compressed and/or encrypted preliminary feature vector from the edge system;
decrypt and/or decompress the preliminary feature vector; and
analyze the decrypted and/or decompressed preliminary feature vector through an inference engine which implements a model associated with the neural network, thereby yielding a final feature vector.

3. The distributed neural network communication system as claimed in claim 2, wherein the model run by the cloud system is an artificial intelligence (AI) model designed to detect objects or events and/or draw inferences from the input data stream.

4. The distributed neural network communication system as claimed in claim 2, wherein the preliminary feature analysis process includes motion detection or object detection, involving dividing frames of the input data stream into frame blocks and analyzing each frame block to check structural similarity to previous frames or frame blocks.

5. The distributed neural network communication system as claimed in claim 4, wherein as part of the preliminary feature analysis process, feature extraction is carried out based only on the frame blocks in respect of which significant changes were detected.

6. The distributed neural network communication system as claimed in claim 2, wherein the cloud system is coupled to a plurality of edge systems, each of the edge systems transmitting compressed and/or encrypted preliminary feature vectors to the cloud system.

7. The distributed neural network communication system as claimed in claim 6, wherein the cloud system comprises a message broker which is configured to handle streams of incoming messages from the edge systems, each message including a compressed and encrypted preliminary feature vector along with metadata associated with the preliminary feature vector.

8. The distributed neural network communication system as claimed in claim 2, wherein the cloud system is configured such that analysis is conducted by separate worker nodes or worker modules substantially in parallel, each worker node/module implementing the inference engine in respect of a different feature vector or feature vector stream, thereby distributing AI tasks across difference devices, instances or processors.

9. The distributed neural network communication system as claimed in claim 2, wherein the distributed neural network communication system is further configured to implement a feedback mechanism.

10. The distributed neural network communication system as claimed in claim 9, wherein the cloud system is configured to determine whether a collection rate or sampling rate should be increased or decreased and to communicate a change to the collection rate or the sampling rate to the edge system, via the feedback mechanism, as an input instruction.

11. The distributed neural network communication system as claimed in claim 1, wherein the edge system is an edge computer directly connected to the input device and connected to the cloud system via the Internet.

12. The distributed neural network communication system as claimed in claim 1, wherein the input device is a video camera; and the input data stream is video data.

13. The distributed neural network communication system as claimed in claim 1, wherein the preliminary feature vector and/or final feature vector is associated with a detected object or a detected event.

14. A distributed neural network communication method, the method comprising:
receiving, at an edge system which is communicatively coupled to a cloud system, an input data stream from an input device;
extracting, by the edge system, a preliminary feature vector from the input data stream through a preliminary feature analysis process;
compressing and/or encrypting, by the edge system, the preliminary feature vector;
transmitting the compressed and/or encrypted preliminary feature vector to the cloud system;
decrypting and/or decompressing the preliminary feature vector at the cloud system; and
analyzing, by the cloud system, the decrypted and/or decompressed preliminary feature vector through an inference engine which implements a model associated with a neural network, thereby yielding a final feature vector.

15. The distributed neural network communication method as claimed in claim 14, wherein the model run by the cloud system is an artificial intelligence (AI) model designed to detect objects or events and/or draw inferences from the input data stream.

16. The distributed neural network communication method as claimed in claim 14, wherein the preliminary feature analysis process includes motion detection or object detection, involving dividing frames of the input data stream into frame blocks and analyzing each frame block to check structural similarity to previous frames or frame blocks, and wherein as part of the preliminary feature analysis process, feature extraction is carried out based only on the frame blocks in respect of which significant changes were detected.

17. The distributed neural network communication method as claimed in claim 14, wherein the cloud system is coupled to a plurality of edge systems, each of the edge systems transmitting compressed and/or encrypted preliminary feature vectors to the cloud system, and wherein the cloud system comprises a message broker which is configured to handle streams of incoming messages from the edge systems, each message including a compressed and encrypted preliminary feature vector along with metadata associated with the preliminary feature vector.

18. The distributed neural network communication method as claimed in claim 14, wherein the cloud system is configured such that analysis is conducted by separate worker nodes or worker modules substantially in parallel, each worker node/module implementing the inference engine in respect of a different feature vector or feature vector stream, thereby distributing AI tasks across difference devices, instances or processors.

19. A computer program product for distributed neural network communication, the computer program product comprising at least one computer-readable storage medium having program instructions embodied therewith, the program instructions being executable by at least one computer to cause the at least one computer to perform a plurality of operations comprising:
receiving, at an edge system which is communicatively coupled to a cloud system, an input data stream from an input device;
extracting, by the edge system, a preliminary feature vector from the input data stream through a preliminary feature analysis process;
compressing and/or encrypting, by the edge system, the preliminary feature vector;
transmitting the compressed and/or encrypted preliminary feature vector to the cloud system;
decrypting and/or decompressing the preliminary feature vector at the cloud system; and
analyzing, by the cloud system, the decrypted and/or decompressed preliminary feature vector through an inference engine which implements a model associated with a neural network, thereby yielding a final feature vector.

20. The computer program product as claimed in claim 19, wherein the computer-readable storage medium is a non-transitory storage medium.
